(19) United States
(12) Patent Application Publication
(10) Pub. No.: US 2024/0206528 A1
(43) Pub. Date: Jun. 27, 2024

(54) MOUTHPIECE LINING PAPER WITH NANO-EMBOSSING

(71) Applicant: TANNPAPIER GMBH, Traun (AT)

(72) Inventors: Michael LINDNER, Wartberg ob der Aist (AT); Bernhard KNAUSEDER, Leonding (AT)

(73) Assignee: TANNPAPIER GMBH, Traun (AT)

(21) Appl. No.: 18/289,084

(22) PCT Filed: May 2, 2022
(86) PCT No.: PCT/AT2022/060150

§ 371 Date: Oct. 31, 2023

(30) Foreign Application Priority Data
May 4, 2021 (AT) A 50344/2021

(51) Int. Cl. A24C 5/56; A24C 5/60; D21H 19/34

(52) U.S. Cl. CPC A24C 5/565; A24C 5/601; D21H 19/34

(57) ABSTRACT

The invention relates to a nano-embossed mouthpiece lining paper which has a lacquer layer comprising nitrocellulose or ethyl cellulose, wherein the lacquer layer is either a clear lacquer layer or a colored lacquer layer and is provided with a nano-structure by mechanical embossing.

### CROSS-REFERENCE TO RELATED APPLICATIONS

The present application is a national phase application of PCT Application No. PCT/AT2022/060150, filed May 2, 2022, entitled “TIPPING PAPER WITH NANO-EMBOSSING”, which claims the benefit of Austrian Patent Application No. A 50344/2021, filed May 4, 2021, each of which is incorporated by reference in its entirety.

### BACKGROUND OF THE INVENTION

### 1. Field of the Invention

The invention relates to a mouthpiece lining paper with nano-embossing.

### 2. Description of the Related Art

The invention relates in particular to mouthpiece lining paper for cigarettes and heat-not-burn consumer articles or, in general, for mouthpieces of aerosol-generating consumer articles.

The mouthpiece lining paper, often referred to as “tipping paper” or “tipping” for short, is that part of the aerosol-generating consumer article that is touched by the person's lips when smoking a filter cigarette or when heating the heat-not-burn consumer article. The mouthpiece lining paper envelops the filter part and usually also protrudes slightly in the longitudinal direction of the consumer article into the longitudinal region of the tobacco rod or the aerosol-generating substrate and there envelops the cigarette paper or the wrapping material of the aerosol-generating substrate.

The mouthpiece lining paper is in most cases actually a paper, but it can also be a foil or a composite material made of several layers of different materials.

The mouthpiece lining paper often has a printing. For example, this printing can be an imitation of cork. However, mouthpiece lining papers are also used which are white in the area that is touched by the lips.

In order to increase the resistance of the mouthpiece lining paper to moisture, it is known to provide a so-called lip-release coating in any area of the mouthpiece lining paper which is touched by the lips.

It is known to form a colored printing, in particular cork printing, by means of a colored lacquer and to additionally apply a lacquer over this colored lacquer. This additional lacquer is known as lip release lacquer. In addition, it is known to first apply a clear lacquer to a white mouthpiece lining paper and then an additional lip release lacquer, which can also consist of an additional layer of the clear lacquer. Another known embodiment is to first print the mouthpiece lining paper with a non-film-forming printing ink, apply a clear lacquer over this printing and apply an additional lacquer layer for the lip release effect over the clear lacquer.

### SUMMARY OF THE INVENTION

The object of the invention is to improve the moisture resistance or the water-repellent properties of a clear lacquer or colored lacquer in order to create alternatives to the application of an additional lip release lacquer.

To achieve the object, a mouthpiece lining paper is proposed which has a clear lacquer layer or colored lacquer layer based on a nitrocellulose lacquer or ethyl cellulose lacquer, the lacquer layer being provided with a nano-structure by a mechanical embossing process.

The nano-structure in the clear lacquer layer or colored lacquer layer advantageously achieves a lotus effect or improves the hydrophobic effect of the lacquer layer.

The nano-structure further achieves optical effects which make counterfeiting of the mouthpiece lining paper more difficult.

Known methods are suitable for producing the nano-structure, as is in particular disclosed in EP 2222711 B1.

From EP 2222711 B1 it is known to achieve special optical effects, which can be decorative and make imitation difficult. This is done by forming a nano-structure in a layer of a thermoplastic carbohydrate polymer, in particular a hydrophobic starch ester. EP 2222711 B1 mentions cigarette paper as a possible application, but does not disclose a specific implementation for carrying out the method on cigarette paper. In technical jargon, the paper of a cigarette that envelops the tobacco rod is referred to as cigarette paper, the cigarette generally having an additional mouthpiece lining paper which has different properties from the cigarette paper.

The nano-embossing is carried out, for example, at a temperature of at least 90° C., in particular at least 100° C. and a pressure of 1.5 bar.

The depth of the depressions in the nano-embossed structure can also be found in EP 2222711 B1 and is preferably in the range from 10 nm to 1500 nm, particularly preferably 50 nm to 1000 nm and in particular 75 nm to 800 nm.

The distance between the depressions of the nano-embossed structure is preferably in the range from 10 nm to 1500 nm, particularly preferably 50 nm to 1000 nm and in particular 100 to 500 nm.

In the present invention, a continuous area is preferably provided with the nano-embossed structure, which area extends in the form of a band along an entire side of the mouthpiece lining paper so that an annular region with a nano-embossed structure is present on the aerosol-generating article. The individual microstructures of the nano-embossed structure are preferably close to one another or without gaps in order to obtain a continuous area with improved water-repellent properties.

The nano-embossing is preferably carried out on a continuously moving band of mouthpiece lining paper, which is provided with the nano-structure between two rollers (embossing roller and counter-pressure roller) by transferring the embossing structure of the embossing roller into the lacquer layer by means of heat and pressure, with either the rollers being heated and/or the lacquer layer being heated prior to embossing.

The present invention provides a suitable layer structure of the mouthpiece lining paper, suitable lacquer compositions, and a system for making mechanical embossing processes applicable for the production of a nano-structured mouthpiece lining paper.

The term lacquer refers to a film-forming substance.

In a first embodiment, the lacquer is a clear lacquer which hardens to form a transparent lacquer layer.

Particularly preferably, the clear lacquer is nitrocellulose lacquer.

The clear lacquer comprises nitrocellulose or ethyl cellulose and one or more solvents selected from the group of solvents comprising: ethanol, ethyl acetate, isopropanol. The solvents mentioned can be in the form of an aqueous solution, so that the lacquer comprises nitrocellulose or ethyl cellulose, an organic solvent and water. The clear lacquer can also comprise effect pigments (e.g. pearlescent, metallic, etc.).

The clear lacquer composition is preferably applied in an amount of 0.25 g/m² to 2 g/m², particularly preferably 0.5 g/m² to 1 g/m².

The clear lacquer can also be in the form of a gloss lacquer which contains effect pigments, for example in the form of metallic effect pigments, pearlescent pigments or interference pigments. The gloss lacquer preferably comprises nitrocellulose or ethyl cellulose, effect pigments and one or more solvents selected from the group of solvents comprising: ethanol, ethyl acetate, isopropanol. The solvents mentioned can preferably be in the form of an aqueous solution, so that the lacquer comprises nitrocellulose or ethyl cellulose, effect pigments and an organic solvent and water.

The gloss lacquer composition is preferably applied in an amount of 0.25 g/m² to 8 g/m², particularly preferably 2 g/m² to 6 g/m².

In a second embodiment, the lacquer is a colored lacquer which hardens to form a colored lacquer layer. The colored lacquer layer is preferably opaque. The colored lacquer layer can be designed in a bright color, or in grey or black.

The colored lacquer comprises nitrocellulose or ethyl cellulose and colored pigments and one or more solvents selected from the group of solvents comprising: ethanol, ethyl acetate, isopropanol. The solvents mentioned can be in the form of an aqueous solution, so that the colored lacquer comprises nitrocellulose or ethyl cellulose, colored pigments and an organic solvent and water. The colored lacquer can also contain additives and/or fillers.

The colored lacquer can also comprise effect pigments (e.g., pearlescent, metallic, etc.). The effect pigments can be, for example, metallic effect pigments, pearlescent pigments or interference pigments.

The colored lacquer composition is preferably applied in an amount of 0.25 g/m² to 8 g/m², particularly preferably 1 g/m² to 4 g/m².

The colored lacquer is preferably applied in the form of a single-colored coating on the surface. The coating can be present as a band or a plurality of bands that are spaced apart from one another.

The lacquer composition has a viscosity of 8 to 30 seconds, in particular 10-25 seconds. The clear lacquer preferably has a viscosity of 8 to 16 seconds, in particular 10-14 seconds. The viscosity value is determined using a flow cup test with a cup diameter of 4 mm (ISO cup 4 mm according to EN ISO 2431 version 1993-02-15).

The clear lacquer or colored lacquer is preferably applied by gravure printing, in particular rotogravure printing.

The lacquer layer is preferably applied in one layer, less preferably in two layers.

The application is preferably carried out directly on the base paper of the mouthpiece lining paper.

The base paper preferably has a grammage of 30 to 60 g/m², particularly preferably 30 to 50 g/m².

The lacquer is preferably applied to an untreated surface of the base paper. The base paper is therefore preferably not coated.

In one embodiment, the coating takes place in the form of one or more bands of colored lacquer, which are present on white base paper. The coated mouthpiece lining paper preferably has at least one white area and one area with a colored lacquer, these areas preferably each running in the form of a band in the circumferential direction of the aerosol-generating consumer article.

The mouthpiece lining paper preferably has a lacquer application which mimics the appearance of cork.

As already described, the lacquer application can be a colored lacquer layer in one embodiment.

In a second embodiment the lacquer application can be a non-film-forming coating or printing, for example in the form of a colored ink or printing ink, wherein clear lacquer is applied over the colored coating as described above. The clear lacquer layer is preferably present continuously over the entire mouthpiece lining paper or registered to a band-shaped colored layer or several band-shaped colored layers.

The nano-embossing takes place in the clear lacquer layer or in the colored lacquer layer.

The nano-embossing is preferably carried out over the entire surface of the mouthpiece lining paper or registered to a band-shaped lacquer layer or several band-shaped lacquer layers.

The nano-embossing is preferably carried out on an entire surface independently of the colored coating, since the nano-structure is not or barely visible in white areas.

The lacquer is applied to a continuously moving material web of the base paper. After the application, the material web is preferably moved through a drying device.

Heating dryers, in particular hot air dryers and/or heated rollers, are preferably used as drying devices. Less preferably, infrared emitters can also be used alternatively or additionally.

After the lacquer layer has dried, the material web is rolled up onto a bobbin or fed directly to the embossing device for the production of the nano-structure. After the nano-structure has been produced, the material web is rolled up onto a bobbin or the nano-structured material web is fed to a cigarette manufacturing machine.

The lacquer layer is preferably applied over a continuous area and at least in the area that is touched by the lips.

The finished nano-structured mouthpiece lining paper preferably comprises a base paper on which a lacquer layer is applied, the nano-structure being embossed in the lacquer layer.

Less preferably, the mouthpiece lining paper can comprise a foil, in particular made of cellulose hydrate, in addition to the base paper. Less preferably, the mouthpiece lining paper can consist of a foil, in particular made of cellulose hydrate, or be a laminate of several foils.

The mouthpiece lining paper can also have foil elements, in particular metallic foil elements. These are in particular applied as thin bands or logos.

These foil elements are preferably applied before the nano-embossing of the mouthpiece lining paper. The application takes place according to known methods, in particular by embossing processes such as in particular hot foil embossing, wherein the foil element is applied to the mouthpiece lining paper by pressure or pressure and heat from a transfer element. In this case, the nano-embossing also gives the foil elements an optical effect.

Foil elements can less preferably also be applied after nano-embossing.

Foil elements can also be provided with optical effects by embossing before they are transferred to the mouthpiece lining paper, so that the foil elements and the lacquer layer are provided with different embossings or different effects.

The invention also comprises a plant for the production of a mouthpiece lining paper, comprising:
a machine for coating the mouthpiece lining paper with lacquer,
a machine for hot foil embossing the mouthpiece lining paper and
a machine for nano-embossing the mouthpiece lining paper.

Optionally, a machine for printing the mouthpiece lining paper with ink can be arranged upstream of the machine for coating the mouthpiece lining paper with lacquer, or the machine for coating the mouthpiece lining paper with lacquer can also have means for printing with a printing ink.

Optionally, there can also be a machine for printing the mouthpiece lining paper, which prints multi-colored logos on the mouthpiece lining paper.

The mouthpiece lining paper is moved as a band through the respective machine, the application of lacquer and the nano-embossing preferably taking place continuously in the longitudinal direction of the band.

In an advantageous embodiment, the band of the mouthpiece lining paper is not transferred from one machine to the next, but rather wound up onto a bobbin after the respective machine and transferred to the next machine.

The band, which is moved through the machine for coating the mouthpiece lining paper with lacquer, is composed of several mouthpiece lining papers transversely to the direction of movement, wherein any direction of the mouthpiece lining paper which is transverse to the direction of movement, i.e. along the width of the band, is later arranged in the longitudinal direction of the consumer article. The band preferably has a number of 10 to 60, in particular 15 to 25, individual mouthpiece lining papers transversely to the direction of movement.

The machine for coating the mouthpiece lining paper with lacquer preferably has a cutting device, which cuts the band in the longitudinal direction after it has been provided with the lacquer layer, so that at least two narrower bands of lacquer-coated mouthpiece lining papers are obtained, which are each wound onto a bobbin.

These bobbins with narrower bands are preferably fed to the device for hot foil embossing the mouthpiece lining papers and provided with foil elements.

The machine for hot foil embossing the mouthpiece lining paper preferably has a cutting device which cuts the band in the longitudinal direction after it has been provided with at least one foil element, so that at least two narrower bands of mouthpiece lining papers coated with lacquer and provided with foil elements are obtained, which are each wound onto a bobbin.

These bobbins with even narrower bands are preferably fed to the machine for nano-embossing the mouthpiece lining paper and provided with a nano-embossing.

In other embodiments, the machine for nano-embossing can be connected directly to the machine for coating with lacquer or the machine for hot foil embossing the mouthpiece lining paper, without being rolled up onto a bobbin in between.

If the machine for nano-embossing follows the machine for coating with lacquer, the material web can be cut in the longitudinal direction before or after the machine for nano-embossing in order to obtain narrower material webs. In this case, the machine for hot foil embossing the mouthpiece lining paper can follow the machine for nano-embossing.

### BRIEF DESCRIPTION OF THE DRAWINGS

The invention is illustrated with the aid of drawings:

FIG. 1: illustrates the application of an exemplary mouthpiece lining paper according to the invention on a filter cigarette.

FIG. 2: illustrates the application of an exemplary mouthpiece lining paper according to the invention on a heat-not-burn consumer article.

FIG. 3: illustrates the application of an exemplary mouthpiece lining paper according to the invention on a filter cigarette.

FIG. 4: illustrates an exemplary mouthpiece lining paper according to the invention.

### DETAILED DESCRIPTION

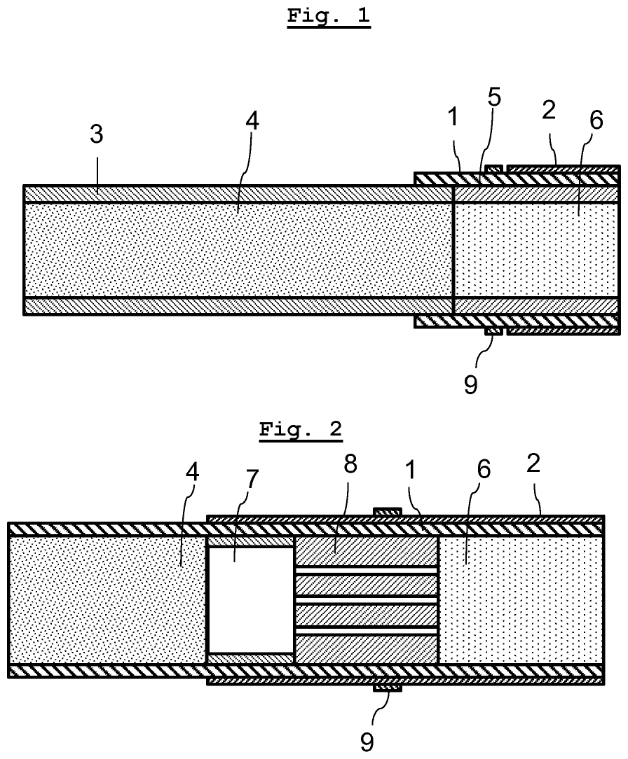

FIG. 1 illustrates an exemplary structure of a filter cigarette which is equipped with a mouthpiece lining paper 1 according to the invention which comprises a lacquer layer 2 which has an embossed nano-structure.

A conventional filter cigarette further comprises a cigarette paper 3, which envelops a rod 4 of aerosol-generating substrate, which in the case of a filter cigarette is usually referred to as a tobacco rod. A conventional filter cigarette further comprises a filter paper 5 which envelops the filter 6. The present mouthpiece lining paper 1 can also be provided on cigarettes without a filter.

FIG. 2 illustrates an exemplary structure of a heat-not-burn consumer article which is equipped with a mouthpiece lining paper 1 according to the invention, which comprises a lacquer layer 2, which lacquer layer 2 has an embossed nano-structure.

A conventional heat-not-burn consumer article further comprises a rod 4 of aerosol-generating substrate, a hollow section 7, a cooling section 8 and a filter 6. These sections may or may not include their own wrapping materials.

Since the rod 4 is heated in the heat-not-burn consumer article without burning the wrapping material, the mouthpiece lining paper 1 can extend over the entire length of the heat-not-burn consumer article. The mouthpiece lining paper 1 can be designed in multiple layers and, for example, have an internal aluminum layer, at least in the area of the rod 4. In contrast to what is shown, a mouthpiece lining paper 1 can also be attached to the heat-not-burn consumer article, which only extends over a partial area of the heat-not-burn consumer article, in which case an additional wrapping material for the rod and optionally also the other components 6, 7, 8 may be provided.

The heat-not-burn consumer article can be heated with an electronic device (heat-not-burn device), wherein the heat-not-burn consumer article is introduced into the device with the rod 4 first, so that the mouthpiece lining paper 1 and the lacquer layer 4 present thereon are exposed for the user's lips. As shown, there is preferably no lacquer layer in the area in which the rod 4 is present, or in the area which is fed into the heat-not-burn device.

In another known embodiment of a heat-not-burn consumer article, the latter itself has a heat source in front of the rod 4, in particular in the form of carbon, so that the rod 4 can be heated without an electronic device.

The lacquer layer 2 can, as shown in FIGS. 1 and 2, extend only over a partial area of the mouthpiece lining paper 1, and only be present in the rear end of the aerosol-generating consumer article facing away from the rod 4.

The mouthpiece lining paper 1 can have perforations, which can be present in the area which is not provided with a lacquer layer 2, or can run through the lacquer layer 2 and the base paper.

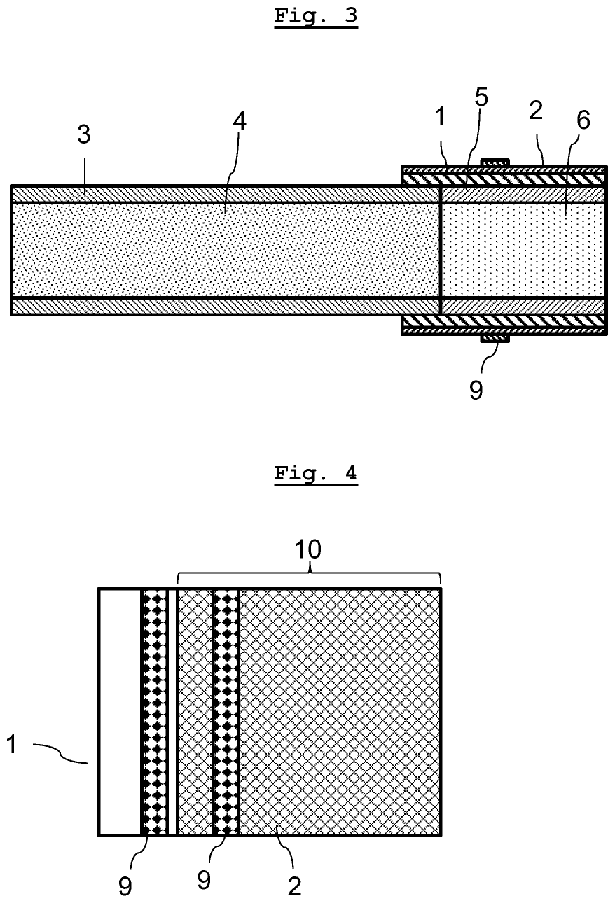

In another embodiment, the mouthpiece lining paper 1 can be provided with the lacquer layer 2 over the entire surface, as illustrated in FIG. 3.

As illustrated in FIGS. 1 to 3, the mouthpiece lining paper 1 can additionally have a foil element 9, which can be applied over the lacquer layer 2 or in an area which is not covered by the lacquer layer 2.

The lacquer layer 2 can be a clear lacquer layer or a colored lacquer layer.

In the case of a clear lacquer layer, this can be located on white base paper or on colored printed or coated base paper. The clear lacquer layer can cover a larger area than the colored printing or coating.

In the case of a colored lacquer layer, this itself forms the colored coating or the colored area of the mouthpiece lining paper.

FIG. 4 shows a strip of a single mouthpiece lining paper 1 in a view from above, which comprises a base paper, a lacquer layer 2, a colored coated area 10, a nano-embossing and two foil elements 9. The visible embossing structure of the nano-embossing is illustrated by the diamond pattern. In the example, the nano-embossing is provided both in the lacquer layer 2 and on the foil elements 9.

If it is desired that the foil elements 9 do not have the nano-structure, these can be applied after the nano-embossing has been carried out, or the nano-embossing can be performed registered outside the areas with foil elements 9.

In the example, the mouthpiece lining paper 1 is provided in one area with a colored coating 10 which is formed from a colored lacquer layer or is formed from a colored coating which is covered with a clear lacquer layer. In the example of FIG. 4, the clear lacquer layer could extend over the entire surface of the mouthpiece lining paper. The nano-embossing structure can also extend over the entire surface of the mouthpiece lining paper.

Due to the dark background in the area of the colored printing, the nano-embossed structure becomes visible as an optical effect, while this is hardly visible in the area of a white mouthpiece lining paper 1 covered with clear lacquer.

It is important to mention that the nano-embossed structure can only be produced in the lacquer layer 2 and the foil elements 9, while exposed areas of the base paper, which result from a coating with lacquer in limited areas, do not have the embossed structure, even if the base paper is processed in the same way in the machine for producing nano-embossing.

The examples are to be understood as purely explanatory. The mouthpiece lining paper 1 with the lacquer layer 2, which has an embossed nano-structure, can be present on any type of aerosol-generating consumer article, for example as wrapping material for cigars or cigarillos, or as sheets of wrapping material for roll-your-own cigarettes.

The mouthpiece lining paper 1 is to be arranged on the aerosol-generating consumer article in such a way that the lacquer layer 2 is located on the outside of the aerosol-generating consumer article. If the lacquer layer 2 is only present in a partial area, this area is to be arranged facing away from the rod 4.

1-12. (canceled)

13. A nano-embossed mouthpiece lining paper, comprising:
a lacquer layer comprising one of nitrocellulose and ethyl cellulose;
wherein the lacquer layer is one of a clear lacquer layer and a colored lacquer layer; and
wherein the lacquer layer is provided with a nano-structure by mechanical embossing.

14. The nano-embossed mouthpiece lining paper according to claim 13, wherein the lacquer layer comprises nitrocellulose.

15. The nano-embossed mouthpiece lining paper according to claim 13, further comprising a base paper with a grammage of 30 to 60, the base paper being provided with the lacquer layer.

16. The nano-embossed mouthpiece lining paper according to claim 13, wherein the lacquer layer is a colored lacquer layer which comprises colored pigments.

17. The nano-embossed mouthpiece lining paper according to claim 13, wherein the lacquer layer is a clear lacquer layer which is applied over a colored area of the mouthpiece lining paper.

18. The nano-embossed mouthpiece lining paper according to claim 17, wherein the colored area of the mouthpiece lining paper is formed by a non-film-forming ink or printing ink.

19. The nano-embossed mouthpiece lining paper according to claim 13, wherein the mouthpiece lining paper comprises at least one foil element.

20. The nano-embossed mouthpiece lining paper according to claim 19, wherein the lacquer layer and the foil element are provided with the same nano-structure.

21. An aerosol-generating consumer article comprising:
a nano-embossed mouthpiece lining paper including a lacquer layer comprising one of nitrocellulose and ethyl cellulose;
wherein the lacquer layer is one of a clear lacquer layer and a colored lacquer layer;
wherein the lacquer layer is provided with a nano-structure by mechanical embossing; and
wherein the nano-embossed lacquer layer is exposed on the outside of the consumer article.

22. A device for producing a nano-embossed mouthpiece lining paper, comprising:
a first machine for coating the mouthpiece lining paper with lacquer;
a second machine for hot foil embossing the mouthpiece lining paper; and
a third machine for nano-embossing the mouthpiece lining paper;
wherein the nano-embossed mouthpiece lining paper includes a lacquer layer comprising one of nitrocellulose and ethyl cellulose;
wherein the lacquer layer is one of a clear lacquer layer and a colored lacquer layer;
wherein the lacquer layer is provided with a nano-structure by mechanical embossing; and
wherein a band can be transported through each machine, which band is composed in the transverse direction of several mouthpiece lining papers for one aerosol-generating consumer article each.

23. The device according to claim 22, wherein the first machine has a cutting device for cutting the band in a longitudinal direction and has a winding device which rolls up the cut narrower bands onto bobbins.

24. The device according to claim 23, wherein:
the second machine has a cutting device for cutting the band in a longitudinal direction and has a winding device which rolls up the cut narrower bands onto bobbins; and
the second machine is located in a manufacturing process downstream of the first machine and upstream of the third machine.
